(19) United States
(12) Patent Application Publication
(10) Pub. No.: US 2023/0088914 A1
(43) Pub. Date: Mar. 23, 2023

(54) DISK DEVICE WITH SENSOR MOUNTED THEREON

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Yuu KAWAI, Shinagawa Tokyo (JP)

(21) Appl. No.: 17/686,035

(22) Filed: Mar. 3, 2022

(30) Foreign Application Priority Data
Sep. 22, 2021 (JP) 2021-154448

(51) Int. Cl. G11B 33/12; G06F 3/06; G11B 33/02; G11B 5/54

(52) U.S. Cl. CPC G11B 33/122; G06F 3/0676; G11B 33/022; G11B 5/54; G11B 2220/2516

(57) ABSTRACT

A disk device includes a magnetic disk, a magnetic head configured to read information from and write information to the magnetic disk, a housing having a mounting space in which the magnetic disk and the magnetic head are mounted, a substrate, and a sensor. The housing includes a wall and a hole extending therethrough to the mounting space. The substrate is attached to an outer side of the wall and sealing the hole. The sensor is mounted on the substrate.

### CROSS-REFERENCE TO RELATED APPLICATION

This application is based upon and claims the benefit of priority from Japanese Patent Application No. 2021-154448, filed Sep. 22, 2021, the entire contents of which are incorporated herein by reference.

### FIELD

Embodiments described herein relate generally to a disk device.

### BACKGROUND

A disk device such as a hard disk has a magnetic disk and a magnetic head that reads information from and writes information to the magnetic disk. Further, a sensor may be mounted on the disk device for, for example, read-write performance improvement. The disk device with the sensor is capable of performing correction processing based on a detection result of the sensor.

A sensor in the disk device is mounted on, for example, a printed circuit board (PCB) positioned outside a housing or a flexible printed circuit board (FPC) positioned in the housing. However, with such a mounting manner of the sensor, noise may be introduced into the detection result of the sensor.

### BRIEF DESCRIPTION OF THE DRAWINGS

FIG. 1 illustrates a perspective view of a disk device according to a first embodiment.

FIG. 2 illustrates a perspective view of the disk device according to the first embodiment in an exploded manner.

FIG. 3 illustrates a perspective view of a part of the disk device according to the first embodiment in an exploded manner.

FIG. 4 illustrates a cross-sectional view of a part of the disk device according to the first embodiment along F4-F4 line in FIG. 3.

FIG. 5 illustrates a plan view of a relay component included in the disk device according to the first embodiment.

FIG. 6 illustrates a plan view of a relay component included in a disk device according to a second embodiment.

FIG. 7 illustrates a cross-sectional view of a part of the relay component in the second embodiment along F7-F7 line in FIG. 6.

FIG. 8 illustrates a cross-sectional view of a part of a disk device according to a third embodiment.

FIG. 9 illustrates a cross-sectional view of a part of a disk device according to a fourth embodiment.

### DETAILED DESCRIPTION

Embodiments provide a disk device capable of reducing noise in a detection result of a sensor.

In general, according to an embodiment, a disk device includes a magnetic disk, a magnetic head configured to read information from and write information to the magnetic disk, a housing having a mounting space in which the magnetic disk and the magnetic head are mounted, a substrate, and a sensor. The housing includes a wall and a hole extending therethrough to the mounting space. The substrate is attached to an outer side of the wall and sealing the hole. The sensor is mounted on the substrate.

### First Embodiment

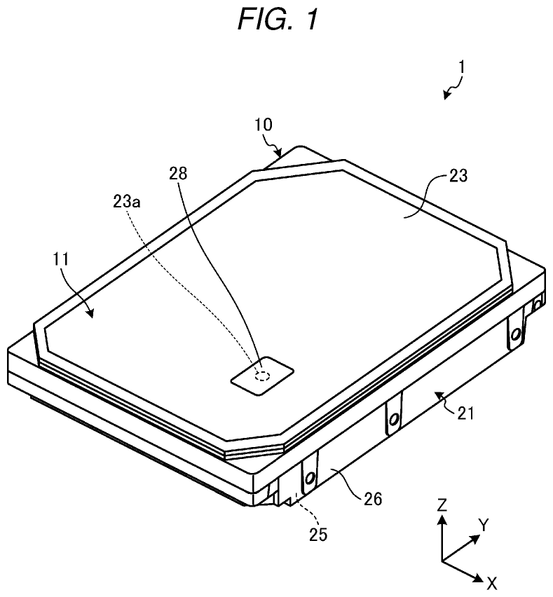

A first embodiment will be described below with reference to FIGS. 1 to 5. In the present specification, component elements according to one or more embodiments and description of the elements may be described in a plurality of expressions. The component elements and the description thereof are examples and are not limited by the expressions in the present specification. The component elements may also be identified by names different from those in the present specification. In addition, the component elements may be described by expressions different from those in the present specification.

FIG. 1 illustrates a perspective view of a hard disk drive (HDD) 10 according to the first embodiment. The HDD 10 is, for example, mounted on an electronic device 1 and configures a part of the electronic device 1. In other words, the electronic device 1 has the HDD 10.

The HDD 10 is an example of a disk device and may also be referred to as a storage device or a magnetic disk device. The electronic device 1 is, for example, a device such as various computers including a personal computer, a supercomputer, a server, a television receiver, or a game machine, or an external hard drive (external HDD).

The X, Y, and Z axes in the drawings are defined for convenience in the present specification. The X, Y, and Z axes are mutually orthogonal. The X axis is along the width of the HDD 10. The Y axis is along the length of the HDD 10. The Z axis is along the thickness of the HDD 10.

Further, X, Y, and Z directions are defined in the present specification. The X direction is along the X axis and includes a+X direction indicated by the arrow of the X axis and a−X direction opposite to the arrow of the X axis. The Y direction is along the Y axis and includes a +Y direction indicated by the arrow of the Y axis and a −Y direction opposite to the arrow of the Y axis. The Z direction is along the Z axis and includes a +Z direction indicated by the arrow of the Z axis and a −Z direction opposite to the arrow of the Z axis.

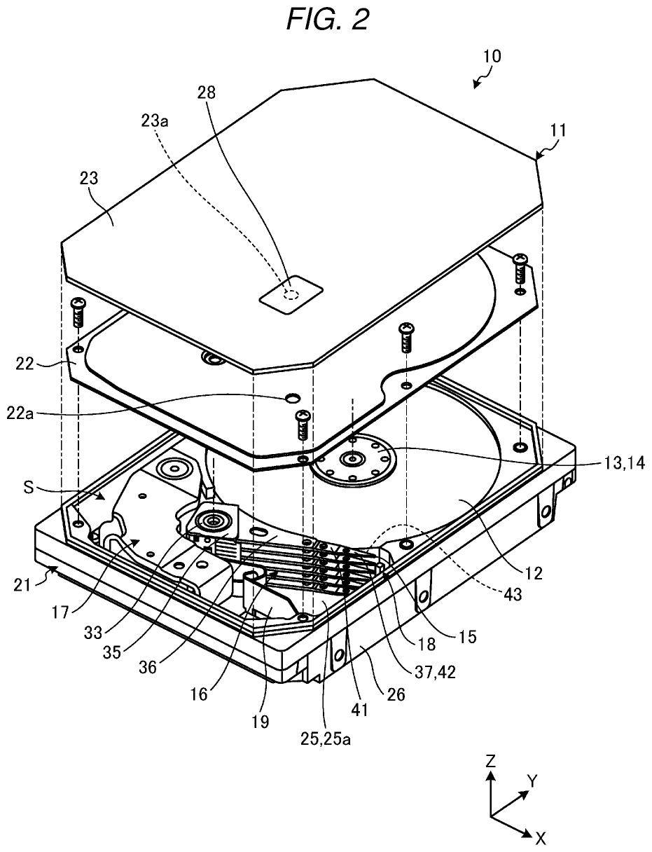

FIG. 2 illustrates a perspective view of the HDD 10 according to the first embodiment in an exploded manner. As illustrated in FIG. 2, the HDD 10 has a housing 11, a plurality of magnetic disks 12, a spindle motor 13, a clamp spring 14, a plurality of magnetic heads 15, an actuator assembly 16, a voice coil motor (VCM) 17, a ramp load mechanism 18, and a flexible printed circuit board (FPC) 19. The FPC 19 is an example of an internal component.

The housing 11 has a base 21, an inner cover 22, and an outer cover 23. The base 21 is a bottomed container and has a bottom wall 25 and side walls 26. The bottom wall 25 is an example of a wall. The bottom wall 25 is formed in the shape of a substantially rectangular (quadrangular) plate extending along the XY plane. The side walls 26 protrude in the +Z direction from the outer edges of the bottom wall 25. The bottom wall 25 and the side walls 26 are made of a metal material such as an aluminum alloy and are integrally formed.

The inner cover 22 and the outer cover 23 are made of a metal material such as an aluminum alloy. The inner cover 22 is attached to an end portion of the side wall 26 in the +Z direction by, for example, a screw. The outer cover 23 covers the inner cover 22 and is airtightly fixed to the end portion of the side wall 26 in the +Z direction by, for example, welding.

An accommodating space S (also referred to herein as “mounting space”) is provided in the housing 11. The accommodating space S is formed (defined, partitioned) by the base 21 and the inner cover 22. The housing 11 in the present embodiment airtightly seals the accommodating space S to prevent or reduce gas movement between the accommodating space S and the outside of the housing 11.

The magnetic disk 12, the spindle motor 13, the clamp spring 14, the magnetic head 15, the actuator assembly 16, the voice coil motor 17, the ramp load mechanism 18, and the FPC 19 are accommodated in the accommodating space S in the housing 11. The bottom wall 25 and the side wall 26 of the base 21 and the inner cover 22 cover the accommodating space S and the components accommodated in the accommodating space S.

The inner cover 22 includes a vent 22a. Further, the outer cover 23 includes a vent 23a. After components are attached to the inside of the base 21 and the inner cover 22 and the outer cover 23 are attached to the base 21, the air in the accommodating space S is released from the vents 22a and 23a. Further, the accommodating space S is filled with a gas different from air.

Examples of the gas with which the accommodating space S is filled include a low-density gas with lower density than air and an inactive gas with low reactivity. For example, the accommodating space S is filled with helium. The accommodating space S may be filled with another fluid. In addition, the accommodating space S may be kept in a vacuum, at a low pressure close to a vacuum, or at a negative pressure lower than the atmospheric pressure.

The vent 23a of the outer cover 23 is sealed with a seal 28. The seal 28 is made of, for example, metal or synthetic resin. The seal 28 airtightly seals the vent 23a and prevents the gas with which the accommodating space S is filled from leaking from the vent 23a.

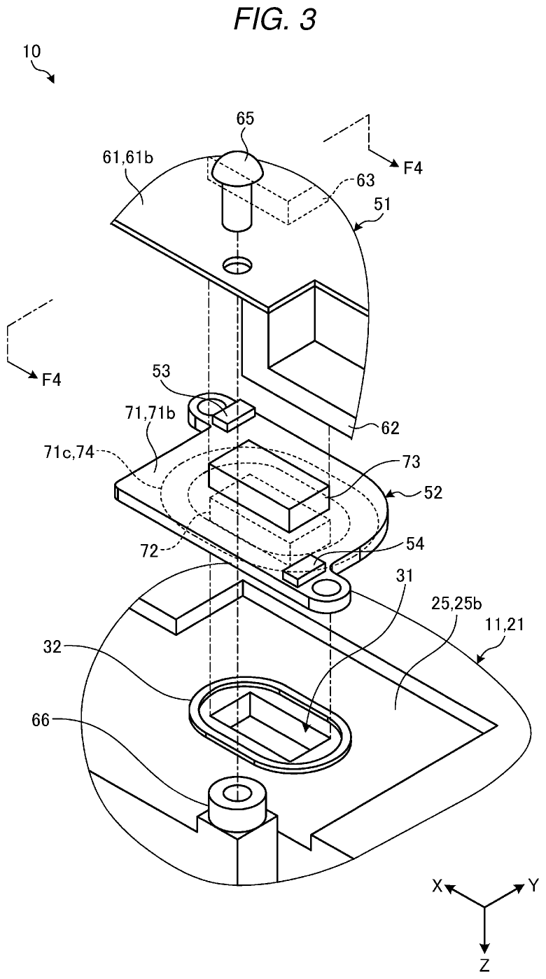

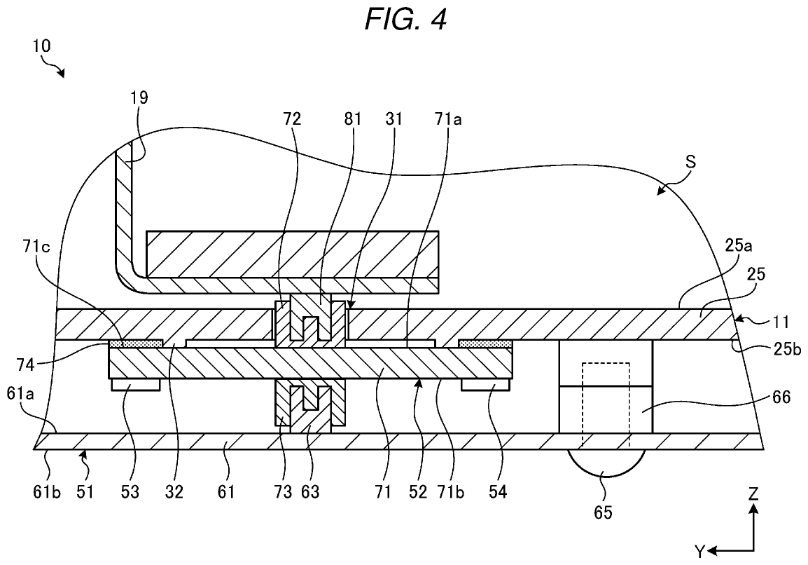

FIG. 3 illustrates a perspective view of a part of the HDD 10 according to the first embodiment in an exploded manner. FIG. 4 illustrates a cross-sectional view of a part of the HDD 10 according to the first embodiment along the F4-F4 line in FIG. 3. As illustrated in FIG. 4, the bottom wall 25 has an inner surface 25a and an outer surface 25b.

The inner surface 25a faces the inside of the accommodating space S. The inner surface 25a is, for example, formed substantially flat along the XY plane and faces the” +Z direction. The outer surface 25b is positioned on the side opposite to the inner surface 25a and faces the outside of the housing 11. The outer surface 25b is, for example, formed substantially flat along the XY plane and faces the −Z direction.

A hole 31 is provided in the bottom wall 25. The hole 31 penetrates the bottom wall 25 in the substantially Z direction and communicates with the accommodating space S. Accordingly, the hole 31 extends between the inner surface 25a and the outer surface 25b. The hole 31 is, for example, a slit having a substantially rectangular cross section extending in the X direction. The hole 31 may be formed in another shape.

The base 21 further has a protrusion 32. The protrusion 32 protrudes from the outer surface 25b of the bottom wall 25. The protrusion 32 is formed in a frame shape surrounding the hole 31 in the plane of the inner surface 25a (i.e., the XY plane). The length of the protrusion 32 in the Z direction is substantially constant.

The magnetic disk 12 illustrated in FIG. 2 is, for example, a disk having a magnetic recording layer provided on at least one of upper and lower surfaces. Although the diameter of the magnetic disk 12 is, for example, 3.5 inches, the diameter is not limited to this example.

The spindle motor 13 supports and rotates the plurality of magnetic disks 12 stacked at intervals. The clamp spring 14 holds the plurality of magnetic disks 12 at the hub of the spindle motor 13.

The magnetic head 15 records information to and reproduces information from the recording layer of the magnetic disk 12. In other words, the magnetic head 15 reads information from and writes information to the magnetic disk 12. The magnetic head 15 is supported by the actuator assembly 16.

The actuator assembly 16 is rotatably supported by a support shaft 33 disposed at a position separate from the magnetic disk 12. The VCM 17 rotates the actuator assembly 16, and the actuator assembly 16 is disposed at a desired position as a result. When the magnetic head 15 moves to the outermost periphery of the magnetic disk 12 by the VCM 17 rotating the actuator assembly 16, the ramp load mechanism 18 holds the magnetic head 15 at an unload position separated from the magnetic disk 12.

The actuator assembly 16 has an actuator block 35, a plurality of arms 36, and a plurality of head suspension assemblies (suspensions) 37. The suspension 37 may also be referred to as a head gimbal assembly (HGA).

The actuator block 35 is rotatably supported by the support shaft 33 via, for example, a bearing. The plurality of arms 36 protrude from the actuator block 35 in a direction substantially orthogonal to the support shaft 33. In some embodiments, the actuator assembly 16 is a multi-actuator assembly having a plurality of actuator blocks, from each of which a plurality of arms protrude.

The plurality of arms 36 are disposed at intervals in the direction in which the support shaft 33 extends. Each of the arms 36 is formed in a plate shape so as to be capable of entering the gap between the magnetic disks 12 that are adjacent to each other. The plurality of arms 36 extend substantially in parallel.

The actuator block 35 and the plurality of arms 36 are integrally formed and may be formed of, for example, aluminum. The materials of the actuator block 35 and the arm 36 are not limited to this example.

The voice coil of the VCM 17 is provided at the protrusion that protrudes from the actuator block 35. The VCM 17 has a pair of yokes, the voice coil disposed between the yokes, and a magnet provided at the yoke.

The suspension 37 is attached to a tip part of the corresponding arm 36 and protrudes from the arm 36. As a result, the plurality of suspensions 37 are disposed at intervals in the direction in which the support shaft 33 extends.

Each of the plurality of suspensions 37 has a base plate 41, a load beam 42, and a flexure 43. Further, the magnetic head 15 is attached to the suspension 37.

The base plate 41 and the load beam 42 are made of, for example, stainless steel. The materials of the base plate 41 and the load beam 42 are not limited to this example. The base plate 41 is formed in a plate shape and is attached to a tip portion of the arm 36. The load beam 42 is formed in a plate shape and thinner than the base plate 41. The load beam 42 is attached to the tip portion of the base plate 41 and protrudes from the base plate 41.

The flexure 43 is formed in an elongated band shape. The shape of the flexure 43 is not limited to this example. The flexure 43 is a stacked plate having a metal plate (backing layer) such as a stainless steel plate, an insulating layer formed on the metal plate, a conductive layer formed on the insulating layer and configuring a plurality of wirings (wiring patterns), and a protective layer (e.g., insulating layer) covering the conductive layer.

A displaceable gimbal portion (e.g., elastic support portion) positioned on the load beam 42 is provided in one end portion of the flexure 43. The magnetic head 15 is mounted on the gimbal portion. The other end portion of the flexure 43 is connected to the FPC 19. As a result, the FPC 19 is electrically connected to the magnetic head 15 via the wiring of the flexure 43.

As illustrated in FIG. 3, the HDD 10 further has a printed circuit board (PCB) 51, a relay component 52, and two sensors 53 and 54. The PCB 51 is an example of an external component. The sensor 53 is an example of a sensor, a second RV sensor, and an impact sensor. The sensor 54 is an example of a first RV sensor.

The PCB 51 is positioned outside the housing 11. The PCB 51 has a printed wiring board (PWB) 61, an interface (I/F) connector 62, and a relay connector 63. The PWB 61 is an example of a second substrate. The second substrate may be another substrate such as an FPC.

The PWB 61 is, for example, a rigid substrate such as a glass epoxy substrate and is a multilayer board, a build-up board, or the like. The PWB 61 extends along the XY plane and is attached to the bottom wall 25.

The PWB 61 is attached to the bottom wall 25 by, for example, using a screw 65. For example, a boss 66 is provided on the bottom wall 25. The PWB 61 is supported by the boss 66 and is attached to the boss 66 with the screw 65 passing through the hole of the PWB 61. The PWB 61 may be attached to the bottom wall 25 by another method such as snap fitting using a hook. The PWB 61 covers the hole 31 of the bottom wall 25 in the Z direction.

As illustrated in FIG. 4, the PWB 61 has an inner surface 61a and an outer surface 61b. The inner surface 61a is formed substantially flat along the XY plane and faces the +Z direction. The inner surface 61a faces the hole 31 provided in the bottom wall 25 and the bottom wall 25 at an interval. The outer surface 61b is opposite to the inner surface 61a.

The I/F connector 62 and the relay connector 63 are mounted on the PWB 61. In addition, various memories (for example, RAM, ROM, and buffer memory), a controller, a servo controller, a coil, a capacitor, and another electronic component may be further mounted on the PWB 61.

The I/F connector 62 is a connector conforming to an interface standard such as Serial ATA and is connected to the I/F connector of the electronic device 1. The I/F connector 62 may be connected to the I/F connector of the electronic device 1 via, for example, a cable.

The relay connector 63 is mounted on the inner surface 61a of the PWB 61. The relay connector 63 is aligned with the hole 31 in the Z direction. Accordingly, the relay connector 63 protrudes from the inner surface 61a toward the hole 31 of the housing 11. The relay connector 63 may be disposed at another position.

The relay component 52 has a relay board 71, two relay connectors 72 and 73, and an adhesive 74. The relay board 71 is an example of a substrate. The relay connector 72 is an example of a first connector. The relay connector 73 is an example of a second connector. The adhesive 74 is an example of an adhesive substance. The adhesive substance may be another substance capable of bonding a plurality of objects, examples of which include pewter and solder.

The relay board 71 is, for example, a multilayer PWB. The relay board 71 may be another substrate. The relay board 71 extends along the XY plane and is attached to the bottom wall 25. The relay board 71 covers the hole 31 of the bottom wall 25 in the Z direction.

The relay board 71 has a first surface 71a and a second surface 71b. The first surface 71a is substantially flat along the XY plane and faces the +Z direction. The first surface 71a faces the bottom wall 25 and the hole 31 provided in the bottom wall 25. In other words, the hole 31 is positioned within the edges of the first surface 71a. In other words, the hole 31 is overlapped entirely in the Z direction by interior portions of the first surface 71a. The second surface 71b faces the inner surface 61a.

The thickness of the relay board 71 in the Z direction is larger than the thickness of the PWB 61 in the Z direction. In addition, the relay board 71 is smaller in area than the PWB 61 in the plane of the first surface 71a. In other words, the area of the first surface 71a is smaller than the area of the inner surface 61a. Accordingly, the rigidity of the relay board 71 is higher than the rigidity of the PWB 61. The Z direction is an example of a direction orthogonal to the first surface.

The relay connector 72 is mounted on the first surface 71a. The relay connector 72 is aligned with the hole 31 in the Z direction. The relay connector 72 passes through the hole 31. In other words, at least a part of the relay connector 72 is accommodated in the hole 31. As a result, the relay connector 72 is exposed to the accommodating space S.

The relay connector 72 is connected to a relay connector 81 (see FIG. 4) mounted on the FPC 19. In other words, the relay connector 72 is connected to the FPC 19 through the hole 31. The relay connector 81 is electrically connected to the magnetic head 15 through the wiring of the FPC 19 and the flexure 43.

The relay connector 72 may be positioned outside the hole 31. In this case, the relay connector 81 is connected to the relay connector 72 extending through the hole 31. Also, in this case, the relay connector 72 is connected to the FPC 19 through the hole 31.

The relay connector 73 is mounted on the second surface 71b. The relay connector 73 is electrically connected to the relay connector 72 through, for example, a conductor such as a via provided on the relay board 71. The relay connector 73 is aligned with the hole 31, the relay connector 63, and the relay connector 72 in the Z direction.

The relay connector 73 is connected to the relay connector 63 of the PCB 51. As a result, the relay component 52 electrically connects the FPC 19 accommodated in the accommodating space S and the PCB 51 outside the housing 11.

The relay connectors 63, 72, 73, and 81 are used for, for example, power supply and signal transmission between the FPC 19 and the PCB 51. For example, the magnetic head 15 and the controller of the PCB 51 transmit read and write signals to each other through the flexure 43, the FPC 19, the relay connectors 63, 72, 73, and 81, and the PWB 61. The relay connectors 63, 72, 73, and 81 may be used only for power supply or may be used for other purposes.

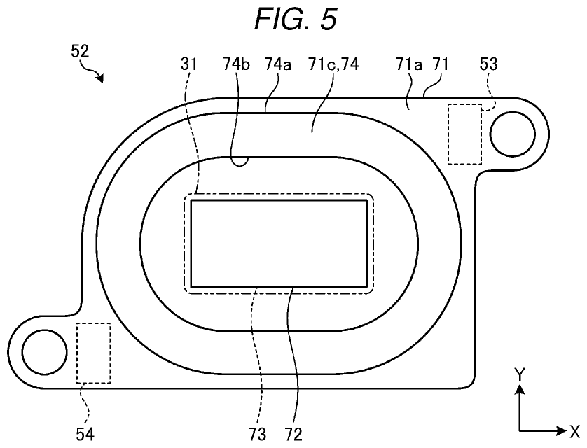

FIG. 5 illustrates a plan view of the relay component 52 in the HDD 10 according to the first embodiment. As illustrated in FIG. 5, an adhesive region 71c is provided on the first surface 71a of the relay board 71. The adhesive region 71c is the frame-shaped part of the first surface 71a that surrounds the hole 31 and the relay connector 72 in the plane of the first surface 71a. In FIG. 5, the hole 31 is virtually indicated by a two-dot chain line. In the adhesive region 71c, the conductive layer of the relay board 71 such as a copper foil is exposed. The adhesive region 71c is not limited to this example.

As illustrated in FIG. 4, the adhesive region 71c is positioned outside the frame-shaped protrusion 32 in the plane of the first surface 71a. The adhesive region 71c surrounds the protrusion 32 in the plane along the first surface 71a.

The adhesive 74 adheres to substantially the entire region of the adhesive region 71c. Accordingly, the adhesive 74 surrounds the hole 31, the protrusion 32, and the relay connector 72 in the plane of the first surface 71a. Since the copper foil is exposed in the adhesive region 71c, the adhesive 74 is capable of adhering to the adhesive region 71c with the gap therebetween reduced.

The adhesive 74 bonds the adhesive region 71c of the first surface 71a to the outer surface 25b of the bottom wall 25. The adhesive 74 includes a metal filler mixed therein and is capable of preventing, for example, a gas from passing through the adhesive 74.

The adhesive 74 airtightly seals the gap between the first surface 71a and the outer surface 25b. As a result, the relay board 71 is attached to the bottom wall 25 and airtightly seals the hole 31. In other words, the relay board 71 blocks the hole 31.

The relay board 71 may not completely seal the hole 31. For example, the relay board 71 may have a fine hole. The relay board 71 airtightly blocks the hole 31 to the extent that leakage of the gas in the accommodating space S falls in a predetermined range during the use life of the HDD 10. In other words, the relay board 71 prevents or reduces gas movement between the accommodating space S and the outside of the housing 11 through the hole 31.

The relay board 71 may be attached to the bottom wall 25 by another tool such as a screw. In this case, the relay board 71 is capable of blocking the hole 31 by, for example, the first surface 71a coming into close contact with the protrusion 32. In addition, a packing may be disposed between the first surface 71a and the bottom wall 25.

The protrusion 32 abuts against the first surface 71a of the relay board 71. The protrusion 32 forms a space where the adhesive 74 is disposed between the adhesive region 71c and the outer surface 25b of the bottom wall 25. In addition, the protrusion 32 is capable of blocking the gap between the first surface 71a and the outer surface 25b by abutting against the first surface 71a.

The sensors 53 and 54 are acceleration sensors. In other words, the sensors 53 and 54 perform acceleration detection. In the present embodiment, the sensors 53 and 54 are, for example, rotary vibration (RV) sensors. Each of the sensors 53 and 54 that are RV sensors is a uniaxial acceleration sensor detecting vibration in a straight line direction. The rotary vibration of the HDD 10 is detected based on the combination of the detection results of the two sensors 53 and 54.

At least one of the sensors 53 and 54 may be an RV sensor capable of independently detecting rotary vibration. In this case, one of the sensors 53 and 54 may be an impact sensor. The sensors 53 and 54 are not limited to the above example, may be other sensors, and may be another combination. In addition, the HDD 10 may have three or more sensors.

The sensors 53 and 54 are mounted on the second surface 71b of the relay board 71 at positions separated from each other. The sensors 53 and 54 may be mounted on the first surface 71a or other parts of the relay board 71.

As illustrated in FIG. 5, the sensors 53 and 54 are mounted on the relay board 71 outside the adhesive region 71c and the adhesive 74 in the plane of the first surface 71a. In other words, the sensors 53 and 54 are separated from the region surrounded by an outer edge 74a of the adhesive 74 in the plane of the first surface 71a. The outer edge 74a is the outside edge of the frame-shaped adhesive 74.

Vibration or impact may act on the HDD 10 described above. The sensors 53 and 54 detect acceleration on the HDD 10 and output electric signals based on the acceleration. In the present specification, the acceleration includes angular acceleration.

For example, the controller of the PCB 51 acquires the electric signals as detection results output by the sensors 53 and 54 through the relay board 71, the relay connectors 73 and 63, and the PWB 61. The controller of the PCB 51 performs correction control of at least one of, for example, the magnetic head 15, the VCM 17, and various actuators according to the detection result. As a result, the HDD 10 is capable of more accurately reading information form and writing information to the magnetic disk 12 even when, for example, the data density of the magnetic disk 12 is high. As a result, improvement in performance can be achieved.

The base 21 of the housing 11 has the largest volume and mass among the plurality of components of the HDD 10. Accordingly, the vibration of the base 21 can be regarded as the vibration of the HDD 10. Meanwhile, although various components such as the PWB 61 vibrate with the base 21, these components may have an individual vibration mode different from the vibration mode of the base 21.

In the present embodiment, the sensors 53 and 54 are mounted on the relay board 71. The relay board 71 is attached to the bottom wall 25 of the base 21 by the frame-shaped adhesive 74 and is thicker and smaller than the PWB 61. Accordingly, the vibration mode of the relay board 71 is closer to the vibration mode of the base 21 than, for example, the vibration mode of the PWB 61 is. Accordingly, the sensors 53 and 54 in the present embodiment are capable of detecting the vibration or impact of the base 21 more accurately than in a case where the sensors 53 and 54 are attached to the PWB 61.

In general, the PWB 61 is attached to the housing 11 by the screws 65 at a plurality of points. In this case, the PWB 61 may vibrate between the screws 65. In addition, the node and peak of the vibration appear at different positions depending on the frequency of the vibration. Noise may be introduced into the detection result if the sensor is disposed at the position where the peak and node of the vibration appear.

The relay board 71 in the present embodiment is attached to the bottom wall 25 by the frame-shaped adhesive 74. In addition, the relay board 71 is smaller than the PWB 61. Accordingly, the relay board 71 is capable of preventing the occurrence of vibration between two points of attachment and is furthermore capable of accommodating the sensors 53 and 54.

In general, the I/F connector 62 of the HDD 10 is attached to the I/F connector of the electronic device 1 directly or via a cable. The vibration mode of the PWB 61 may change depending on the manner of connection between the I/F connector 62 and the I/F connector of the electronic device 1.

The sensors 53 and 54 in the present embodiment are attached to the relay board 71 instead of the PWB 61. Accordingly, the sensors 53 and 54 can be attached separately from a connecting structure connecting between the I/F connector 62 and the I/F connector of the electronic device 1.

In general, a part of the PWB 61 may be positioned in the vicinity of the spindle motor 13. When a sensor is disposed on the PWB 61, the sensor may detect the vibration of the spindle motor 13 through the screw 65 and the PWB 61. The vibration of the spindle motor 13 becomes noise in a detection result.

The sensors 53 and 54 in the present embodiment are attached to the relay board 71 instead of the PWB 61. Accordingly, the sensors 53 and 54 are separated from the spindle motor 13 and can be prevented from detecting the vibration of the spindle motor 13.

In the HDD 10 according to the first embodiment described above, the relay board 71 is attached to the bottom wall 25 and blocks the hole 31. In order to block the hole 31, the relay board 71 comes into contact with the bottom wall 25 around, for example, the hole 31 or is fixed to the bottom wall 25 by a substance such as the adhesive 74. Accordingly, the relay board 71 is more likely to move integrally with the housing 11 than the PWB 61 attached to the boss 66 of the housing 11 by, for example, the screw 65. The sensor 53 is mounted on the relay board 71. As a result, the sensor 53 is capable of detecting the acceleration of the relay board 71 moving substantially integrally with the housing 11 and, therefore, is capable of more accurately detecting the acceleration of the housing 11. Accordingly, the HDD 10 according to the present embodiment is capable of reducing the noise in the detection result of the sensor 53.

The PCB 51 is positioned outside the housing 11. The FPC 19 is accommodated in the accommodating space S. The relay connector 72 is mounted on the first surface 71a of the relay board 71 facing the hole 31 and is connected to the FPC 19 through the hole 31. The relay connector 73 is mounted on the second surface 71b of the relay board 71 opposite to the first surface 71a, is electrically connected to the relay connector 72, and is connected to the PCB 51. Accordingly, the HDD 10 according to the present embodiment is capable of electrically connecting the PCB 51 and the FPC 19 through the relay board 71 and the relay connectors 72 and 73. In addition, in the HDD 10 according to the present embodiment, the sensor 53 is mounted on the relay board 71 connecting the PCB 51 and the FPC 19, and thus another component for mounting the sensor 53 is not necessary and an increase in the number of components can be prevented.

The PCB 51 has the PWB 61. The thickness of the relay board 71 in the Z direction is larger than the thickness of the PWB 61 in the Z direction. Accordingly, the relay board 71 can be higher in rigidity than the PWB 61 and is capable of moving more integrally with the housing 11. Accordingly, the sensor 53 is capable of more accurately detecting the acceleration of the housing 11 than in a case where the sensor 53 is mounted on the PWB 61.

The relay board 71 is smaller than the PWB 61 in the plane of the first surface 71a. Accordingly, the relay board 71 can be higher in rigidity than the PWB 61 and is capable of moving more integrally with the housing 11. Accordingly, the sensor 53 is capable of more accurately detecting the acceleration of the housing 11 than in a case where the sensor 53 is mounted on the PWB 61.

The first surface 71a of the relay board 71 is bonded to the bottom wall 25 by the adhesive 74. The adhesive 74 surrounds the hole 31 in the plane of the first surface 71a. In other words, the adhesive 74 blocks the gap between the bottom wall 25 and the relay board 71. As a result, the HDD 10 according to the present embodiment is capable of preventing the accommodating space S and the outside of the housing 11 from communicating with each other through the gap between the bottom wall 25 and the relay board 71. Further, the relay board 71 is attached to the bottom wall 25 more firmly than by, for example, screwing, and thus the sensor 53 is capable of detecting the acceleration of the housing 11 more accurately.

The sensor 53 is mounted on the relay board 71. For electrical connection to the sensor 53, the relay board 71 has a conductive layer including wiring and a terminal to which the sensor 53 is connected. In general, a conductive layer made of metal is capable of preventing gas passage more than a layer made of synthetic resin. However, to achieve electrical separation between the wiring and the terminal to which the sensor 53 is electrically connected and the other part of the conductive layer, an interval (deficiency) is provided between the terminal and wiring and the other part of the conductive layer. Gas passage may occur through the interval, where an insulating layer, for example, synthetic resin is provided. To address such an issue, in the HDD 10 according to the present embodiment, the sensor 53 is mounted on the relay board 71 outside the adhesive 74 in the plane of the first surface 71a. Accordingly, the conductive layer of the relay board 71 is capable of preventing the interval from being provided inside the adhesive 74. Accordingly, the HDD 10 according to the present embodiment is capable of preventing gas passage between the accommodating space S and the outside of the housing 11 through the relay board 71.

The sensor 54 is separated from the sensor 53 and mounted on the relay board 71. The sensors 53 and 54 are RV sensors. In other words, two RV sensors are mounted on the relay board 71. As a result, the two RV sensors are capable of detecting the vibration of the relay board 71 moving substantially integrally with the housing 11 and, therefore, are capable of detecting the vibration of the housing 11 more accurately. Accordingly, the HDD 10 according to the present embodiment is capable of reducing the noise in the detection results of the sensors 53 and 54.

One of the sensors 53 and 54 may be an impact sensor. As a result, the sensor 53 or 54 that is an impact sensor is capable of detecting the impact acting on the relay board 71 moving substantially integrally with the housing 11 and, therefore, is capable of detecting the impact acting on the housing 11 more accurately. Accordingly, the HDD 10 according to the present embodiment is capable of reducing the noise in the detection result of the impact sensor.

The accommodating space S is filled with a gas different from air. For example, the accommodating space S is filled with a low-density gas with lower density than air or an inactive gas with low reactivity. The relay board 71 blocks the hole 31. As a result, the HDD 10 according to the present embodiment is capable of preventing the gas in the accommodating space S from leaking to the outside through the hole 31.

### Second Embodiment

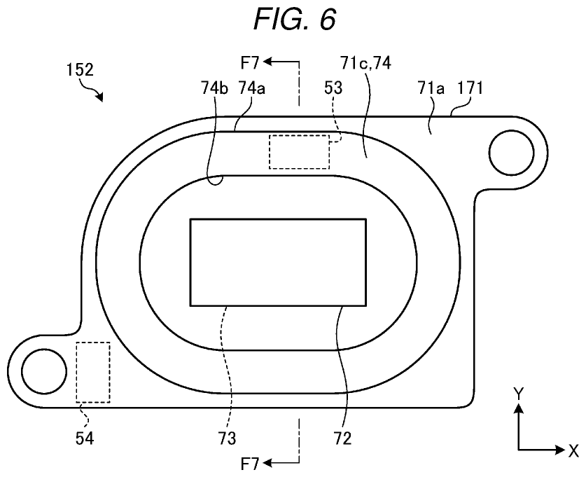

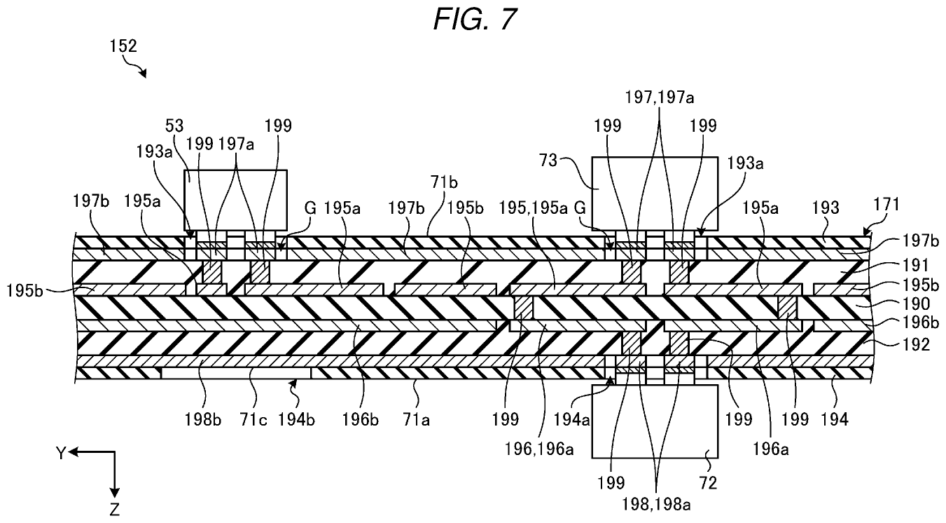

A second embodiment will be described below with reference to FIGS. 6 and 7. In the following description of the second embodiment and following third and fourth embodiments, component elements similar in function to those already described may be denoted by the same reference numerals as those of the component elements described above with redundant description omitted. In addition, the plurality of component elements denoted by the same reference numerals do not necessarily have the same functions and properties without exception and may have different functions and properties in the different embodiments.

FIG. 6 illustrates a plan view of a relay component 152 in a disk device according to the second embodiment. The relay component 152 and a relay board 171 in the second embodiment are the same as the relay component 52 and the relay board 71 in the first embodiment except for the following points.

As illustrated in FIG. 6, in the relay component 152 in the second embodiment, at least a part of the sensor 53 is mounted on the relay board 71 inside the outer edge 74a of the adhesive 74 in a direction along the first surface 71a. In the present embodiment, the sensor 53, the adhesive region 71c, and the adhesive 74 are arranged in the Z direction. In addition, the sensor 53 is positioned between the outer edge 74a and an inner edge 74b of the adhesive 74 in the direction along the first surface 71a. The inner edge 74b is the inside edge of the frame-shaped adhesive 74.

The position of the sensor 53 is not limited to the above example. The sensor 53 may be mounted on the relay board 71 inside the inner edge 74b of the adhesive 74 in the direction along the first surface 71a. In addition, at least a part of the sensor 54 may be mounted on the relay board 71 inside the outer edge 74a of the adhesive 74 in the direction along the first surface 71a.

FIG. 7 illustrates a cross-sectional view of a part of the relay component 152 in the disk device according to the second embodiment along the F7-F7 line in FIG. 6. As illustrated in FIG. 7, the relay board 171 in the second embodiment has three insulating layers 190, 191, and 192, two cover layers 193 and 194, four conductive layers 195, 196, 197, and 198, and a plurality of vias 199.

The insulating layer 191 is an example of an intermediate layer. The intermediate layer may include a plurality of insulating layers and a plurality of conductive layers. The conductive layer 195 is an example of a second conductive layer. The conductive layer 197 is an example of a first conductive layer.

The insulating layers 190, 191, and 192 are made of a synthetic resin such as an epoxy resin. The insulating layers 190, 191, and 192 may be made of another insulating material. The insulating layers 190, 191, and 192 are stacked in the Z direction. The insulating layer 190 is positioned between the two insulating layers 191 and 192.

The cover layers 193 and 194 are, for example, solder resists. The cover layer 193 covers the insulating layer 191 and forms at least a part of the second surface 71b of the relay board 71. The cover layer 194 covers the insulating layer 192 and forms at least a part of the first surface 71a of the relay board 71. Accordingly, the insulating layers 190, 191, and 192 are positioned between the two cover layers 193 and 194.

The conductive layers 195, 196, 197, and 198 are made of a conductor such as copper. The conductive layer 195 is positioned between the insulating layer 190 and the insulating layer 191. The conductive layer 196 is positioned between the insulating layer 190 and the insulating layer 192. The conductive layer 197 is positioned between the insulating layer 191 and the cover layer 193. Accordingly, the insulating layer 191 is positioned between the conductive layer 195 and the conductive layer 197. The conductive layer 198 is positioned between the insulating layer 192 and the cover layer 194.

The conductive layer 195 has a plurality of wiring patterns 195a and a solid pattern 195b. The wiring pattern 195a and the solid pattern 195b are examples of a third conductor pattern. The solid pattern 195b may also be referred to as a metal foil. The wiring patterns 195a are wirings or pads and are separated from each other. The solid pattern 195b is separated from the wiring pattern 195a and extends along the XY plane. The solid pattern 195b is larger than the wiring pattern 195a.

The conductive layer 196 has a plurality of wiring patterns 196a and a solid pattern 196b. The wiring patterns 196a are wirings or pads and are separated from each other. The solid pattern 196b is separated from the wiring pattern 196a and extends along the XY plane. The solid pattern 196b is larger than the wiring pattern 196a.

The conductive layer 197 has a plurality of wiring patterns 197a and a solid pattern 197b. The wiring pattern 197a is an example of a first conductor pattern. The solid pattern 197b is an example of a second conductor pattern.

The wiring patterns 197a are wirings or pads and are separated from each other. The solid pattern 197b is separated from the wiring pattern 197a and extends along the XY plane. The solid pattern 197b is larger than the wiring pattern 197a.

The conductive layer 198 has a plurality of wiring patterns 198a and a solid pattern 198b. The wiring patterns 198a are wirings or pads and are separated from each other. The solid pattern 198b is separated from the wiring pattern 198a and extends along the XY plane. The solid pattern 198b is larger than the wiring pattern 198a.

Each of the plurality of vias 199 is a conductor penetrating at least one of the insulating layers 190, 191, and 192. The via 199 electrically connects two of the wiring patterns 195a, 196a, 197a, and 198a of the conductive layers 195, 196, 197, and 198.

The plurality of wiring patterns 197a include a pad on which the relay connector 73 is mounted and a pad on which the sensors 53 and 54 are mounted. In other words, the plurality of wiring patterns 197a are electrically connected to the relay connector 73 and the sensors 53 and 54. The pad of the wiring pattern 197a is exposed at a plurality of exposure holes 193a provided in the cover layer 193. The relay connector 73 and the sensors 53 and 54 are connected to the pad of the wiring pattern 197a through the exposure hole 193a.

The solid pattern 197b is adjacent to the wiring pattern 197a via a gap G. In other words, the solid pattern 197b is separated from the wiring pattern 197a. The gap G separates the plurality of wiring patterns 197a and the solid pattern 197b in the conductive layer 197.

The plurality of wiring patterns 198a include a pad on which the relay connector 72 is mounted. The pad of the wiring pattern 198a is exposed at an exposure hole 194a provided in the cover layer 194. The relay connector 72 is connected to the pad of the wiring pattern 198a through the exposure hole 194a.

The solid pattern 198b is separated from the wiring pattern 198a. A part of the solid pattern 198b is exposed at an exposure hole 194b provided in the cover layer 194. The exposed solid pattern 198b forms the adhesive region 71c.

The plurality of wiring patterns 195a are connected to the wiring pattern 197a through the vias 199 and are connected to the wiring pattern 196a through the other vias 199. The plurality of wiring patterns 196a are connected to the wiring pattern 198a through the vias 199 and are connected to the wiring pattern 195a through the other vias 199.

The relay connector 72 is electrically connected to the relay connector 73 through the wiring patterns 195a, 196a, 197a, and 198a and the via 199. Further, the sensors 53 and 54 are also electrically connected to the relay connector 73 through, for example, wiring patterns 195a and 197a and the via 199.

At least one of the wiring pattern 195a and the solid pattern 195b overlaps the gap G between the wiring pattern 197a and the solid pattern 197b. In other words, a part of at least one of the wiring pattern 195a and the solid pattern 195b are aligned with the gap G in the Z direction.

The insulating layers 190, 191, and 192 made of synthetic resin may have fine holes. The gas with which the accommodating space S is filled may pass through the holes in the insulating layers 190, 191, and 192. On the other hand, the gas is less likely to pass through the conductive layers 195, 196, 197, and 198 made of metal than through the insulating layers 190, 191, and 192.

The gas in the accommodating space S may, for example, pass through the gap G between the wiring pattern 197a and the solid pattern 197b and enter the fine hole in the insulating layer 191. However, at least one of the wiring pattern 195a and the solid pattern 195b overlaps the gap G. Accordingly, the gas traveling in the Z direction in the insulating layer 191 is blocked by the wiring pattern 195a or the solid pattern 195b.

Likewise, at least one of the adjacent wiring patterns 195a, 196a, 197a, and 198a and solid patterns 195b, 196b, 197b, and 198b overlaps the gaps provided between the wiring pattern 195a and the solid pattern 195b, between the wiring pattern 196a and the solid pattern 196b, and between the wiring pattern 198a and the solid pattern 198b in the Z direction. Accordingly, the relay board 71 is capable of preventing or reducing gas movement between the accommodating space S and the outside of the housing 11.

In the HDD 10 according to the second embodiment described above, at least a part of the sensor 53 is mounted on the relay board 71 inside the outer edge 74a of the adhesive 74 in the plane of the first surface 71a. The relay board 71 has the conductive layer 195, the conductive layer 197, and the insulating layer 191 positioned between the conductive layer 195 and the conductive layer 197. The conductive layer 197 has the wiring pattern 197a electrically connected to the sensor 53 and the solid pattern 197b separated from the wiring pattern 197a. The conductive layer 195 has at least one of the wiring pattern 195a and the solid pattern 195b overlapping the gap G between the wiring pattern 197a and the solid pattern 197b in the Z direction orthogonal to the first surface 71a. In general, the conductive layer 195 made of metal is capable of preventing gas passage more than the insulating layer 191 made of synthetic resin. As a result, the HDD 10 according to the present embodiment is capable of preventing gas passage between the accommodating space S and the outside of the housing 11 through the gap G between the wiring pattern 197a and the solid pattern 197b.

The sensor 53 and the adhesive 74 are aligned in the Z direction orthogonal to the first surface 71a. In other words, the sensor 53 is disposed behind the part of the relay board 71 that is fixed to the bottom wall 25. As a result, the sensor 53 is capable of detecting the acceleration of the housing 11 more accurately. Accordingly, the HDD 10 according to the present embodiment is capable of reducing the noise in the detection result of the sensor 53.

### Third Embodiment

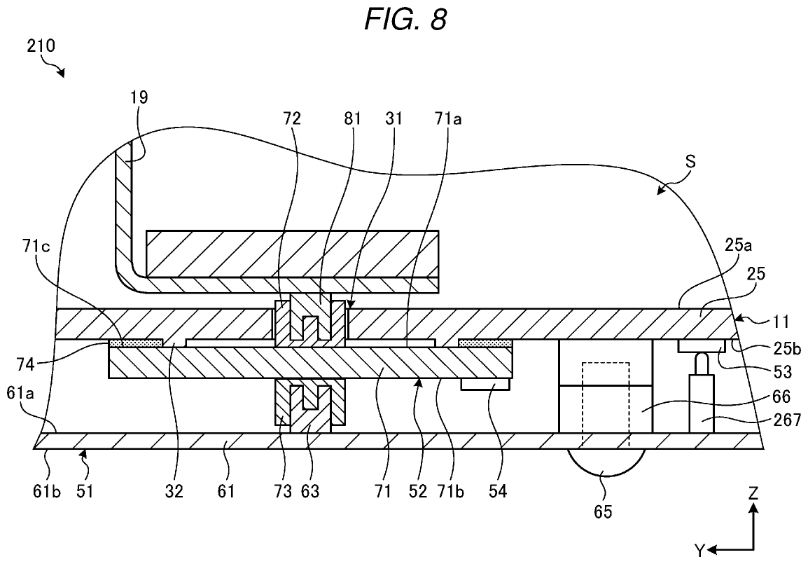

A third embodiment will be described below with reference to FIG. 8. FIG. 8 illustrates a cross-sectional view of a part of an HDD 210 according to the third embodiment. The HDD 210 according to the third embodiment is the same as the HDD 10 according to the first embodiment except for the following points.

In the HDD 210 according to the third embodiment, the sensor 53 is attached to the outer surface 25b of the bottom wall 25 of the housing 11 by, for example, adhesion. Alternatively, the sensor 53 may be attached to another part of the housing 11.

A terminal 267 is mounted on the PWB 61. The terminal 267 is, for example, elastically deformable and comes into contact with the electrode of the sensor 53 with elastic deformation. As a result, the sensor 53 is electrically connected to the PWB 61 through the terminal 267. Alternatively, the sensor 53 may be electrically connected to the PWB 61 by another method.

In the HDD 210 according to the third embodiment described above, the sensor 53 is attached to the housing 11. In other words, one of the two sensors 53 and 54 is mounted on the relay board 71 and the other is attached to the housing 11. As a result, the HDD 210 according to the present embodiment is capable of detecting the vibration of the housing 11 with the two RV sensors even if the relay board 71 is too small to accommodate the two RV sensors. In addition, by being attached to the housing 11, the sensor 53 is capable of detecting the vibration of the housing 11 more accurately.

In general, when two RV sensors detect vibration, the RV sensors are capable of detecting the vibration more accurately as the distance between the two RV sensors increases. The two sensors 53 and 54 in the present embodiment are attached to the housing 11 and the relay board 71, respectively. Accordingly, the HDD 210 according to the present embodiment is capable of increasing the distance between the two sensors 53 and 54 and, therefore, is capable of detecting the vibration of the housing 11 more accurately.

### Fourth Embodiment

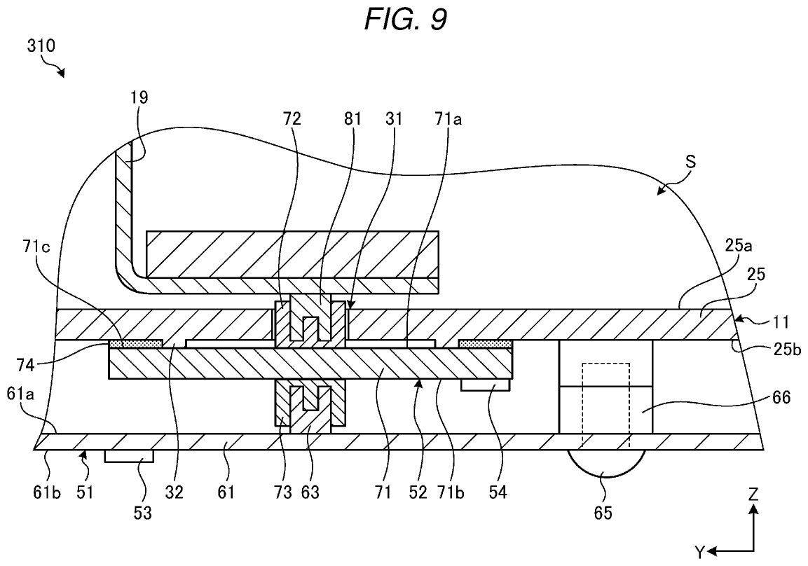

A fourth embodiment will be described below with reference to FIG. 9. FIG. 9 illustrates a cross-sectional view of a part of an HDD 310 according to the fourth embodiment. The HDD 310 according to the fourth embodiment is the same as the HDD 10 according to the first embodiment except for the following points.

In the HDD 310 according to the fourth embodiment, the sensor 53 is attached to the PCB 51. For example, the sensor 53 is mounted on the PWB 61. The sensor 53 may be attached to another part of the PCB 51.

In the HDD 310 according to the fourth embodiment described above, the sensor 53 is attached to the PCB 51. In other words, one of the two sensors 53 and 54 is mounted on the relay board 71 and the other is attached to the PCB 51. As a result, the HDD 310 according to the present embodiment is capable of detecting the vibration of the housing 11 with the two RV sensors even if the relay board 71 is too small to accommodate the two RV sensors.

In the above embodiment, the relay board 71 is positioned outside the housing 11 and is attached to the outer surface 25b of the bottom wall 25. Alternatively, the relay board 71 may be positioned in the accommodating space S and attached to the inner surface 25a of the bottom wall 25. In this case, the connector mounted on the relay board 71 (for example, the relay connector 73) is connected to the PCB 51 through the hole 31.

In addition, in the above embodiment, the sensors 53 and 54 mounted on the relay boards 71 and 171 are acceleration sensors. Alternatively, the sensor mounted on the relay boards 71 and 171 may be another type of sensor.

For example, in general, a temperature sensor, a humidity sensor, and a barometric pressure sensor are mounted on the FPC 19. At least one of the sensors may be mounted on the relay boards 71 and 171 positioned in the accommodating space S. The sensors perform temperature, humidity, and atmospheric pressure detection in the accommodating space S and output electric signals as detection results to the controller of the PCB 51.

The length of the wiring between the sensor and the controller is reduced by at least one of the temperature, humidity, and barometric pressure sensors being mounted on the relay boards 71 and 171 positioned in the accommodating space S. Accordingly, noise introduced into the electric signal as a detection result can be reduced in the wiring between the sensor and the controller. Further, the size of the FPC 19, the wiring in the FPC 19, and the number of pins of the relay connectors 72 and 81 can be reduced. As a result, the HDDs 10, 210, and 310 can be reduced in component size and component cost. Further, the relay connectors 72 and 81 can be reduced in size. As a result, with the HDDs 10, 210, and 310, the hole 31 can be reduced in size and gas movement between the accommodating space S and the outside of the housing 11 through the hole 31 can be prevented or reduced.

In the above description, prevention is defined as, for example, preventing the occurrence of a phenomenon, action, or an effect or reducing the degree of a phenomenon, action, or an effect. In addition, in the above description, limitation is defined as, for example, preventing movement or rotation or allowing movement or rotation within a predetermined range and preventing movement or rotation beyond the predetermined range.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

1. A disk device comprising:
a magnetic disk;
a magnetic head configured to read information from and write information to the magnetic disk;
a housing having a mounting space in which the magnetic disk and the magnetic head are mounted, the housing including a wall and a hole extending therethrough to the mounting space;
a substrate attached to an outer side of the wall and sealing the hole; and
a sensor mounted on the substrate.

2. The disk device according to claim 1, further comprising:
a first connector provided on a first surface of the substrate facing the wall of the housing; and
a second connector provided on a second surface of the substrate opposite to the first surface and electrically connected to the first connector.

3. The disk device according to claim 2, wherein at least a part of the first connector is in the hole.

4. The disk device according to claim 2, further comprising:
an internal component mounted in the housing and including a third connector connected to the first connector, and
an external component disposed out of the housing and including a fourth connector connected to the second connector.

5. The disk device according to claim 4, wherein the external component includes a second substrate on which the fourth connector is provided, a thickness of the substrate being greater than a thickness of the second substrate.

6. The disk device according to claim 5, wherein an area of the substrate is less than an area of the second substrate.

7. The disk device according to claim 1, wherein the substrate is attached to the wall of the housing with an adhesive provided around the hole between the substrate and the wall.

8. The disk device according to claim 7, wherein the sensor is provided on a first surface of the substrate that is opposite to a second surface of the substrate on which the adhesive is provided.

9. The disk device according to claim 7, wherein at least a part of the sensor is aligned with the adhesive in a thickness direction of the substrate.

10. The disk device according to claim 1, wherein
the substrate has a first conductive layer, a second conductive layer, and an intermediate layer between the first conductive layer and the second conductive layer,
the first conductive layer has a first conductor pattern electrically connected to the sensor and a second conductor pattern provided separately from the first conductor pattern, and
the second conductive layer has a third conductor pattern below a gap between the first conductor pattern and the second conductor pattern in a thickness direction of the substrate.

11. The disk device according to claim 1, wherein the sensor is an acceleration sensor.

12. The disk device according to claim 1, wherein the sensor is a rotary vibration (RV) sensor.

13. The disk device according to claim 1, wherein the sensor is an impact sensor.

14. The disk device according to claim 1, further comprising:
a second sensor provided on a surface of the substrate on which the sensor is provided, the sensor and the second sensor being of a same type.

15. The disk device according to claim 1, further comprising:
a second sensor provided on an outer surface of the wall, the sensor and the second sensor being of a same type.

16. The disk device according to claim 1, further comprising:
a second substrate electrically connected to the substrate, the substrate being between the wall of the housing and the second substrate; and
a second sensor provided on the second substrate, the sensor and the second sensor being of a same type.

17. The disk device according to claim 1, wherein a gas different from air is filled in the mounting space.

18. A disk device comprising:
a magnetic disk;
a magnetic head configured to read information from and write information to the magnetic disk;
a flexible print circuit (FPC);
a housing having a mounting space in which the magnetic disk, the magnetic head, and the FPC are mounted, the housing including a wall and a hole extending therethrough to the mounting space;
a circuit board attached to an outer side of the wall;
a relay component attached to the outer side of the wall between the wall and the circuit board and sealing the hole, the FPC and the circuit board being electrically connected via the relay component; and
a sensor mounted on the relay component.

19. The disk device according to claim 18, wherein the relay component includes a first connector connected to a connector on the FPC and a second connector electrically connected to a connector on the circuit board.

20. The disk device according to claim 18, further comprising:
a second sensor mounted on one of the wall, the circuit board, and the relay component, the sensor and the second sensor being of a same type.
